(19) United States
(12) Patent Application Publication
(10) Pub. No.: US 2021/0078180 A1
(43) Pub. Date: Mar. 18, 2021

(54) ROBOT SYSTEM AND CONTROL METHOD OF THE SAME

(71) Applicant: LG ELECTRONICS INC., Seoul (KR)

(72) Inventors: Nakyeong KIM, Seoul (KR); Sungmin MOON, Seoul (KR); Sanghak LEE, Seoul (KR); Jeongkyo SEO, Seoul (KR)

(73) Assignee: LG ELECTRONICS INC., Seoul (KR)

(21) Appl. No.: 16/799,306

(22) Filed: Feb. 24, 2020

(30) Foreign Application Priority Data
Sep. 17, 2019 (KR) 10-2019-0114004

(51) Int. Cl. B25J 11/00; B25J 5/00; B25J 13/08; B25J 13/00; B25J 19/02; B25J 9/16; G05D 1/02

(52) U.S. Cl. CPC B25J 11/008; B25J 5/007; B25J 13/081; B25J 13/003; G05D 1/0246; B25J 19/02; B25J 9/1664; B25J 11/0005; B25J 9/161; B25J 19/026

(57) ABSTRACT

A robot system includes a mobile robot configured to travel by driving wheels, a user interface, via which user service information and user information are input, and a controller configured to select one of at least two paths including a path including a moving walkway by using the user information and generate a map of a selected path, if the user service information and the user information are input via the user interface, and move the mobile robot to the path of a generated map.

### CROSS-REFERENCE TO RELATED APPLICATIONS

This application claims the benefit of priority to Korean Patent Application No. 10-2019-0114004, filed in the Korean Intellectual Property Office on Sep. 17, 2019, the entire contents of which are incorporated herein by reference.

### FIELD OF THE DISCLOSURE

The present disclosure relates to a robot system and a control method of the same.

Robots are machines that automatically process given tasks or operate with their own capabilities. The application fields of robots are generally classified into industrial robots, medical robots, aerospace robots, and underwater robots. Recently, communication robots that can communicate with humans by voices or gestures have been increasing.

Recently, guidance robots for providing various types of guide services in airports or government offices or porter robots such as delivery robots for carrying goods are increasing.

Robots may be mobile robots moving along set movement paths and the movement paths of the mobile robots may include a moving walkway.

The moving walkway may include a conveyor belt and a machine capable of slowly moving inclined roads or flat surfaces.

When a mobile robot stops after entering a moving walkway, the mobile robot may can save power while being located on the moving walkway. A user who moves around the mobile robot along with the mobile robot may enter the moving walkway and move by the moving walkway.

In addition, when the mobile robot enters the moving walkway and then moves on the moving walkway, the mobile robot may move faster when moving outside the moving walkway.

### SUMMARY

An object of the present disclosure is to provide a robot system capable of moving a mobile robot along an optimal traveling path, to which user information is applied, and a method of controlling the same.

According to an embodiment, a robot system includes a mobile robot configured to travel by driving wheels, a user interface, via which user service information and user information are input, and a controller configured to select one of at least two paths including a path including a moving walkway by using the user information and generate a map of a selected path, if the user service information and the user information are input via the user interface, and move the mobile robot to the path of a generated map.

The user service information may include at least one of a request for a guide service provided by the mobile robot and a user's consent to use of the moving walkway.

The user information may include at least one of a user's age, a health level or baggage information.

The at least two paths may include a first traveling path including the moving walkway and a second traveling path which does not include the moving walkway.

The controller may select one of the first traveling path and the second traveling path by using a first traveling distance of the first traveling path, a second traveling distance of the second traveling path and the user information as factors and generate the map.

The controller may move the mobile robot to a traveling path having the shorter traveling distance between the first traveling distance and the second traveling distance, if the user service information is input and the user information is not input.

The controller may calculate a first reference value according to the first traveling distance and a second reference value according to the second traveling distance, and correct the first reference value according to the user information.

The controller may move the mobile robot to a traveling path having the smaller reference value between the corrected first reference value and the second reference value.

The user interface may include a touch interface, via which a user inputs a user's age, baggage information and a health level.

The user interface may include a microphone configured to recognize speech of a user.

The user interface may include a sensor configured to sense an object possessed by a user.

A method of controlling a robot system includes inputting user service information and user information via a user interface, selecting one of at least two paths including a path including a moving walkway using the user information and generating a map, if the user service information and the user information are input, and moving the mobile robot to a path of the generated map.

The user service information may include at least one of a request for a guide service provided by the mobile robot and a user's consent to use of the moving walkway.

The inputting may include an inquiry process of inquiring about a consent to use of a guide service provided by the mobile robot and a user's consent to use of the moving walkway via an output interface.

The user information may include at least one of a user's age, a health level or baggage information.

The inputting may include inputting the user information via a touch interface or a microphone or recognizing an object possessed by a user using a sensor.

The at least two paths may include a first traveling path including the moving walkway and a second traveling path which does not include the moving walkway.

The controller may select one of the first traveling path and the second traveling path by using a first traveling distance of the first traveling path, a second traveling distance of the second traveling path and the user information as factors and generate the map.

The moving may include moving the mobile robot to a traveling path having the shorter traveling distance between the first traveling distance and the second traveling distance, if the user information is not input via the user interface.

The moving includes calculating a first reference value according to the first traveling distance and a second reference value according to the second traveling distance, correcting the first reference value according to the user information, and comparing a corrected first reference value with the second reference value.

The moving may include moving the mobile robot to a traveling path having the smaller reference value between the corrected first reference value and the second reference value.

The corrected first reference value when a user is older may be less than the corrected first reference value when a user is younger.

The corrected first reference value when baggage is present may be less than the corrected first reference value when baggage is absent.

The corrected first reference value when a health condition is uncomfortable may be less than the corrected first reference value when a health condition is healthy.

### BRIEF DESCRIPTION OF THE DRAWINGS

FIG. 1 is a view illustrating an AI device constituting a robot system according to an embodiment.

FIG. 2 is a view illustrating an AI server of a robot system according to an embodiment.

FIG. 3 is a view illustrating an AI system to which a robot system according to an embodiment is applied.

FIG. 4 is a view showing a plurality of traveling paths of a robot according to an embodiment.

FIG. 5 is a view showing a first traveling distance of a first traveling path and a second traveling distance of a second traveling path shown in FIG. 4.

FIG. 6 is a view showing a first traveling distance of a first traveling path before correction and a second traveling distance of a second traveling path shown in FIG. 4.

FIG. 7 is a view showing an example of a first traveling distance of a first traveling path after correction and a second traveling distance of a second traveling path shown in FIG. 4.

FIG. 8 is a view showing another example of a first traveling distance of a first traveling path after correction and a second traveling distance of a second traveling path shown in FIG. 4.

FIG. 9 is a flowchart illustrating a method of controlling a robot system according to an embodiment.

### DETAILED DESCRIPTION OF THE PREFERRED EMBODIMENTS

Hereinafter, preferred embodiments of the present invention will be described in detail with reference to the drawings.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

<Self-Driving>

Self-driving refers to a technique of driving for oneself, and a self-driving vehicle refers to a vehicle that travels without an operation of a user or with a minimum operation of a user. For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

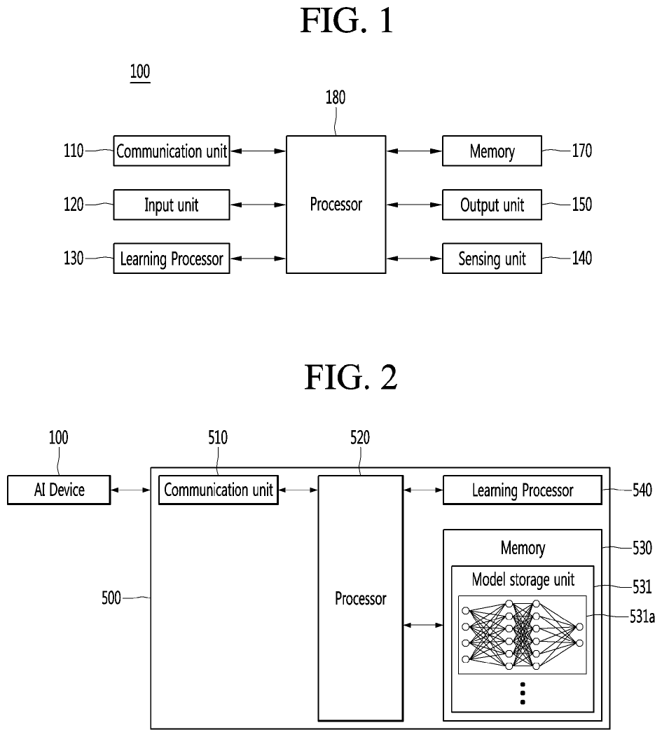

At this time, the self-driving vehicle may be regarded as a robot having a self-driving function. FIG. 1 is a view illustrating an AI device constituting a robot system according to an embodiment.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 500 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like. The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data. The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation. At this time, the learning processor 130 may perform AI processing together with the learning processor 540 of the AI server 500.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information. The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation. When the connection of an external device is required to perform the determined operation, the processor 180 may generate a control signal for controlling the external device and may transmit the generated control signal to the external device. The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 540 of the AI server 500, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 500. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 is a view illustrating an AI server of a robot system according to an embodiment. Referring to FIG. 2, the AI server 500 may refer to a device that learns an artificial neural network by using a machine learning algorithm or uses a learned artificial neural network. The AI server 500 may include a plurality of servers to perform distributed processing, or may be defined as a 5G network. At this time, the AI server 500 may be included as a partial configuration of the AI device 100, and may perform at least part of the AI processing together.

The AI server 500 may include a communication unit 510, a memory 530, a learning processor 540, a processor 520, and the like.

The communication unit 510 can transmit and receive data to and from an external device such as the AI device 100.

The memory 530 may include a model storage unit 531. The model storage unit 531 may store a learning or learned model (or an artificial neural network 531a) through the learning processor 540.

The learning processor 540 may learn the artificial neural network 531a by using the learning data. The learning model may be used in a state of being mounted on the AI server 500 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 530.

The processor 520 may infer the result value for new input data by using the learning model and may generate a response or a control command based on the inferred result value.

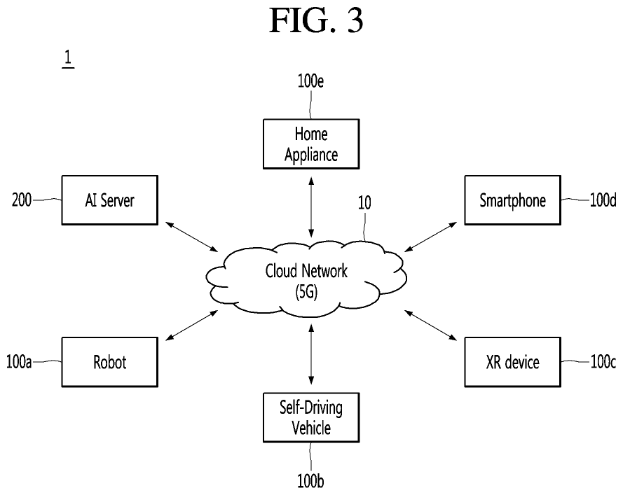

FIG. 3 is a view illustrating an AI system to which a robot system according to an embodiment is applied. Referring to FIG. 3, in the AI system 1, at least one of an AI server 500, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 500 configuring the AI system 1 may be connected to each other through the cloud network 10. In particular, each of the devices 100a to 100e and 500 may communicate with each other through a base station, but may directly communicate with each other without using a base station. The AI server 500 may include a server that performs AI processing and a server that performs operations on big data.

The AI server 500 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 500 may learn the artificial neural network according to the machine learning algorithm instead of the AI devices 100a to 100e, and may directly store the learning model or transmit the learning model to the AI devices 100a to 100e.

At this time, the AI server 500 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 500.

At this time, the robot 100a may perform the operation by generating the result by directly using the learning model, but the sensor information may be transmitted to the external device such as the AI server 500 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

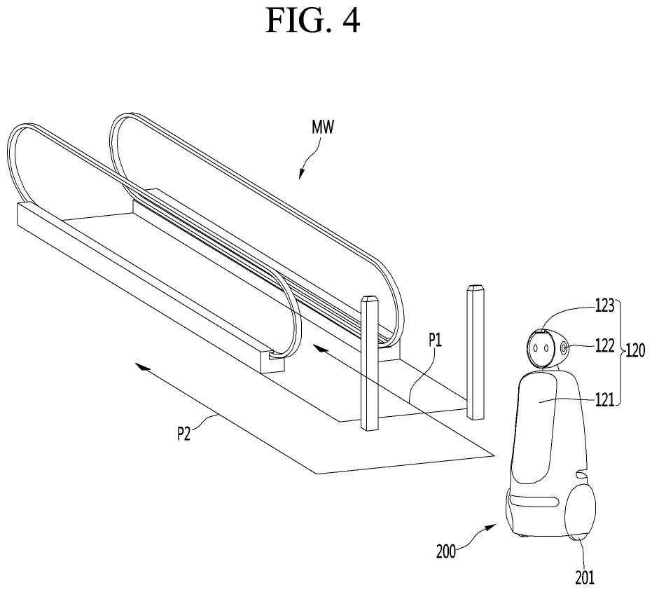

FIG. 4 is a view showing a plurality of traveling paths of a robot according to an embodiment.

The robot system may include a mobile robot 200.

The mobile robot 200 may include driving wheels and may travel along a traveling path.

The mobile robot 200 may include a traveling mechanism connected to the driving wheels to rotate the driving wheels, and the traveling mechanism may include a driving source such as a motor and may further include at least one power transmission member for transmitting the driving force of the driving source to the driving wheels.

When the motor is driven, the driving wheels may be rotated forward and backward and the mobile robot 200 may be moved forward or backward.

The mobile robot 200 may include a steering mechanism capable of changing a forward movement direction or a backward movement direction, and the mobile robot 200 may be moved while turning left or right along the traveling path.

The mobile robot 200 may configure a robot having a self-driving function. The mobile robot 200 may be used in an airport, a government office, a hotel, a mart, a department store, etc. and may be a guidance robot for providing a variety of information to a user, a porter robot for carrying user's goods, or a boarding robot in which a user directly rides.

The mobile robot 200 may move to a destination E along with a user and guide the user to the destination E.

When the destination E is determined by the user, etc., the mobile robot 200 may move along traveling paths P1 and P2 to the destination E.

The mobile robot 200 may move along a traveling path selected from the plurality of traveling paths P1 and P2 along which the mobile robot 200 may move.

The plurality of traveling paths P1 and P2 may include a traveling path having a shortest time from a starting point A to the destination E and a traveling path having a shortest distance from the starting point A to the destination E.

Each of the plurality of traveling paths P1 and P2 may include at least one waypoint B, C and D, through which the mobile robot 200 departing from the starting point A passes before reaching the destination E.

The plurality of traveling paths P1 and P2 may be classified depending on whether a moving walkway MW is included.

The plurality of traveling paths P1 and P2 may include a first traveling path P1 including a moving walkway and at least one second traveling path P2 which does not include a moving walkway.

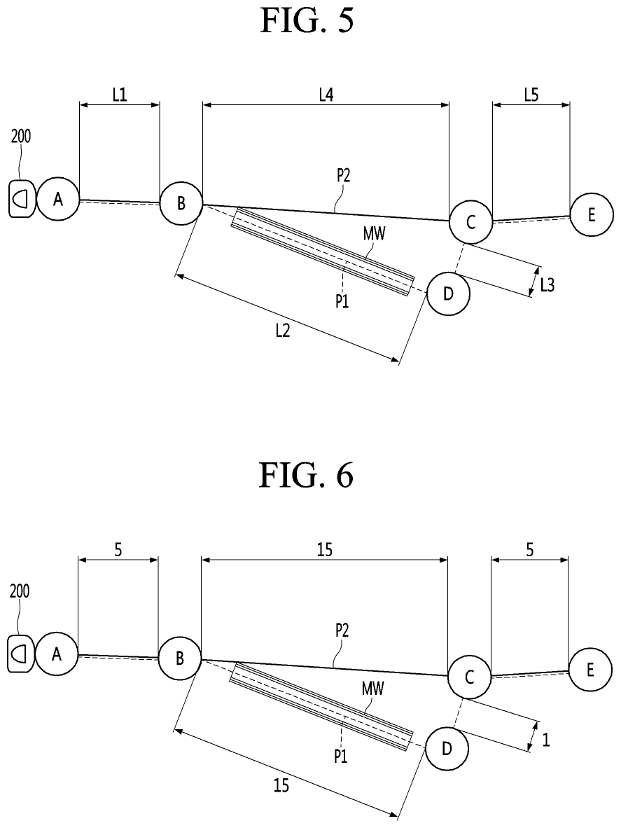

Referring to FIG. 5, the example of the first traveling path P1 may be a path passing through the moving walkway MW while passing through a pair of waypoints B and D or may be a path from the starting point A to the destination E through the waypoints B, C and D.

In addition, referring to FIG. 5, the example of the second traveling path P2 may be a path which does not pass through the moving walkway MW or may be a path from the starting point A to the destination E through the midways B and C.

The robot system may select a specific traveling path from among the plurality of traveling paths P1 and P2 based on at least one factor, and move the mobile robot 200 to the selected traveling path.

Such a factor may include an actual traveling distance from the starting point A to the destination E, a user's condition (e.g., user's age, health level, presence/absence or weight of baggage, etc.) or a user's request.

The robot system may include an output unit 150 for requesting input of user service information and input of user information from a user. The output unit 151 may include a display or a speaker, and the output unit 151 may inquire of the user about the user service information and the user information.

The robot system may include a user interface capable of inputting the user service information and the user information and may include a controller for moving the mobile robot 200.

The user service information may include a request for a guide service provided by the mobile robot 200 and a user's consent to use of the moving walkway.

In addition, the user information may include user's age, health level, baggage information, etc.

An example of the user interface may be an interface of various devices (e.g., a terminal such as a smartphone 100d or a computing device such as a desktop, a laptop or a tablet PC) communicating with the robot 100a directly or via a cloud network 10. In this case, the user may input the user information in advance before the mobile robot 200 is used.

Another example of the user interface may be a robot interface installed in the mobile robot 200.

If the user interface is a robot interface installed in the mobile robot 200, the user interface may configure the robot 100a along with the mobile robot 200, and the user may approach the mobile robot 200 to input the user information.

Hereinafter, it is assumed that the user interface is an input unit 120 which is installed in the mobile robot 200, for example. For convenience, the user interface is denoted by the same reference numeral as the input unit 120. However, the user interface of the present embodiment is not limited to the input unit 120 installed in the mobile robot 200.

The user may input a request for a guide service provided by the mobile robot 200 and a user's consent to use of the moving walkway via the user interface 120.

The user may input a user's age, baggage information and health level via the user interface 120.

An example of the user interface 102 may include a touch interface 121 such as a touchscreen for allowing the user to perform touch input. The touch interface 121 may transmit touch input to the controller when touch of the user is sensed.

Another example of the user interface 120 may include a microphone 122 capable of receiving speech of the user. The microphone 122 may configure a speech recognition module including a speech recognition circuit and transmit the user information recognized by the speech recognition module to the controller.

The robot 100a or various devices (e.g., a terminal, a computing device, etc.) may inquire of a user who wants to use the mobile robot 1200 via a speaker or a display about a user's age, baggage information and health level.

The user may input the user information such as the user's age, the baggage information and health level via the touch interface or provide the user information such as the user's age, the baggage information and health level as an answer by voice.

Another example of the user interface 120 may include a sensor for sensing an object (e.g., an identification card, etc.) possessed by the user. Such a sensor may include a scanner 123.

The scanner 123 may scan the identification (ID) card such as a passport possessed by the user.

The ID card capable of being sensed by the scanner 123 is not limited to the ID card such as the passport, and may include a card via which the user is authorized to use the mobile robot 200. The type of the ID card is not limited if the user information such as user's age, baggage information and a health level is stored.

The sensor may recognize the user information via a barcode included in the ID card and transmit a result of recognition to the controller.

Various devices such as a terminal or a computing device or the mobile robot 200 may guide the user to put the ID card onto the scanner 123 via the speaker or the display.

When the user puts the ID card onto the scanner 123, the user information contained in the ID card may be recognized via the scanner 123 and the scanned result may be transmitted to the controller.

The user's age input via the user interface 120 may be 45, 50, 72, etc., for example.

The baggage information input via the user interface 120 may be information on presence/absence of the baggage or the weight (Kg) of the baggage.

The health level input via the user interface 120 may be information arbitrarily input by the user, such as very healthy, healthy, uncomfortable or very uncomfortable, or information on presence/absence of a disease or the type of a disease.

An example of the controller may include a processor 180 installed in the mobile robot 200 to control the mobile robot 200.

Another example of the controller may include processors of the various devices (e.g., the terminal such as the smartphone 100d, the computing device such as a desktop, a laptop, a tablet PC, etc.).

Another example of the controller may be a server 500.

When the controller is installed in the mobile robot 200, the controller may configure the robot 100a along with the mobile robot 200.

Hereinafter, it is assumed that the controller includes a processor installed in the mobile robot 200, for example. For convenience, the controller is denoted by the same reference numeral as the processor 180. However, the controller of the present embodiment is not limited to the processor 180 installed in the mobile robot 200.

When the user service information is input, the controller 180 may generate a map by selecting one of at least two paths including a path having a moving walkway (MW) and move the mobile robot 200 to the path of the generated map.

At least two paths may include the first traveling path P1 including the moving walkway MW and the second traveling path P2 which does not include the moving walkway MW.

The controller 180 may select the first traveling path P1 including the moving walkway MW or the second traveling path P2 which does not include the moving walkway MW and move the mobile robot 200 to the selected path.

The controller 180 may use the user information when the paths P1 or P2 is selected, and select a path in consideration of the user information.

There is a plurality of factors used to select the first traveling path P1 or the second traveling path P2 and the plurality of factors may include a first traveling distance (first factor) of the first traveling path including the moving walkway MW. The plurality of factors may further include a second traveling distance (second factor) of the second traveling path which does not include the moving walkway. The plurality of factors may include the user information (third factor) input via the user interface 120.

The controller 180 may select one of the first traveling path P1 and the second traveling path P2 according to the first factor, the second factor and the third factor. The controller 180 may generate the map of the selected path and move the mobile robot 200 to the path of the generated map.

Even if the starting point A and the destination E are the same, the mobile robot 200 may move to the first traveling path P1 or the second traveling path P2 according to the user information.

The user may input the destination E via the user interface 120 and input a traveling start command.

The destination E may be a location (or a target) directly input by the user via the input unit 120.

The destination E be a location (or a target) determined by the mobile robot 200 according to a user's inquiry after the user inquires of the mobile robot 200 about the destination E.

The controller 180 may search for the plurality of traveling paths P1 and P2 via map data stored in the memory 170 or map data transmitted from the server 500 or the terminal and one of the plurality of traveling paths P1 and P2 searched by the controller 180 may be a traveling path including the moving walkway.

The user may request to start a guide service from the mobile robot 200 by touching the input unit 120 or inputting a speech command, and the mobile robot 200 may select the first traveling path P1 or the second traveling path P2 from among the plurality of traveling paths P1 and P2 and move to the destination E along the selected path.

When the user information is input, the controller 180 may select one of the first traveling path and the second traveling path in consideration of the first traveling distance (the first factor), the second traveling distance (the second factor) and the user information, and move the mobile robot 200 to the selected traveling path.

When the user information is not input, the controller 180 may move the mobile robot 200 to the shorter traveling distance between the first traveling distance and the second traveling distance.

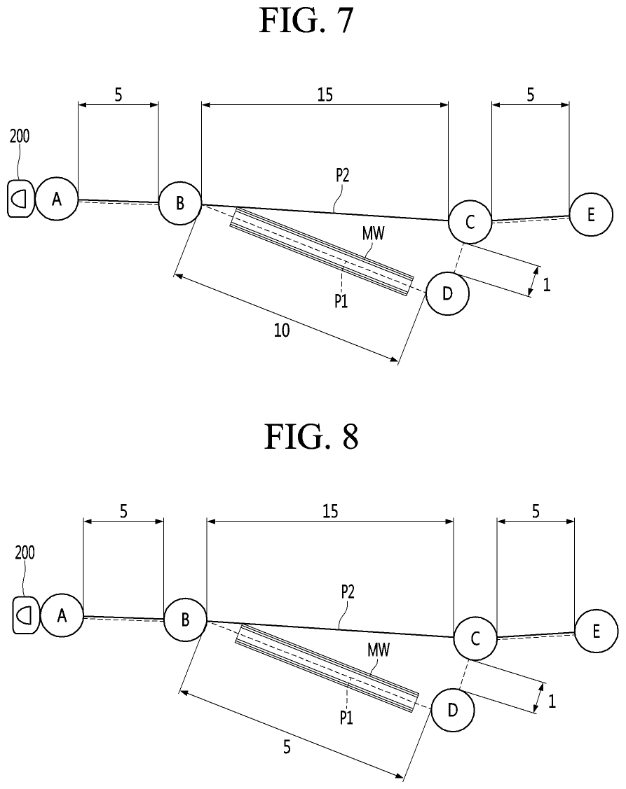

FIG. 5 is a view showing a first traveling distance of a first traveling path and a second traveling distance of a second traveling path shown in FIG. 4, FIG. 6 is a view showing a first traveling distance of a first traveling path before correction and a second traveling distance of a second traveling path shown in FIG. 4, and FIG. 7 is a view showing an example of a first traveling distance of a first traveling path after correction and a second traveling distance of a second traveling path shown in FIG. 4.

In FIGS. 5 to 7, the first traveling path is denoted by a dotted line and the second traveling path is denoted by a solid line.

The controller 180 may calculate a first reference value according to the first traveling distance L1+L2+L3+L5 and a second reference value according to the second traveling distance L1+L4+L5.

The first reference value is determined based on the respective locations of the starting point A, the plurality of waypoints B, D and C and the destination E, and may be variable value which may be changed by the user information.

The second reference value is not changed by the user information, and may be a fixed value determined by the respective locations of the starting point A, at least one waypoints B and C and the destination E.

As shown in FIG. 5, an example of the first traveling distance L1+L2+L3+L5 of the first traveling path P1 may be a sum of a distance L1 from the starting point A to the first waypoint B, a distance L2 from the first waypoint B to the second waypoint D through the moving walkway MW, a distance L3 from the second waypoint D to the third waypoint C, and a distance L5 from the third waypoint C to the destination E.

As shown in FIG. 5, an example of the second traveling distance L1+L4+L5 of the second traveling path P2 may be a sum of the distance L1 from the starting point A to the first waypoint B, a distance L4 from the first waypoint B to the third waypoint C and the distance L5 from the third waypoint C to the destination E.

The controller 180 may correct the first reference value according to the user information.

The controller 180 may move the mobile robot 200 to a traveling path having the smaller reference value between the corrected first reference value and the second reference value.

For convenience of description, it is assumed that the distance L1 from the starting point A to the first waypoint B is 5 m, the distance L2 from the first waypoint B to the second waypoint D is 15 m, the distance L3 from the second waypoint D to the third waypoint C is 1 m, the distance L4 from the first waypoint B to the third waypoint C is 15 m, and the distance L5 from the third waypoint C to the destination E is 5 m.

As shown in FIG. 6, the first reference distance before correction of the first traveling distance L1+L2+L3+L5 may be 26 which is 5+15+1+5, and the second reference value of the second traveling distance L1+L4+L5 may be 25 which is 5+15+5.

The first reference value of the first traveling distance L1+L2+L3+L5 may be corrected by the user information, and the distance L2 from the first waypoint B to the second waypoint D may be corrected to another value which is not 15 m.

As shown in FIG. 7, an example of correction of the first reference value may be determined by presence/absence of baggage. For example, when the user inputs presence of baggage, the distance L2 from the first waypoint B to the second waypoint D may be adjusted to 10 m, instead of 15 m. In this case, the first reference value after correction of the first traveling distance L1+L2+L3+L5 may be 21 which is 5+10+1+5.

In this case, the controller 180 may compare 21 which is the corrected first reference value with 25 which is the fixed second reference value, and select the first traveling path P1 having the smaller reference value as a traveling path, along which the mobile robot 200 will move, and move the mobile robot 200 to the first traveling path P1.

As shown in FIG. 8, another example of correction of the first reference value may be determined by the health level of the user. For example, when the user inputs uncomfortable as the health level, the distance L2 from the first waypoint B to the second waypoint D may be adjusted to 5 m instead of 15 m. In this case, the first reference value after correction of the first traveling distance L1+L2+L3+L5 may be 16 which is 5+5+1+5.

In this case, the controller 180 may compare 16 which is the corrected first reference value with 25 which is the fixed second reference value, select the first traveling path P1 having the smaller reference value as a traveling path, along which the mobile robot 200 will move, and move the mobile robot 200 to the first traveling path P1.

In another example of correction of the first reference value, it is possible to use a specific equation, to which a customer' age, presence/absence of baggage, and a health level are applied, and to correct the first reference value by subtracting a weight calculated by the specific equation from the distance L2 from the first waypoint B to the second waypoint D.

For example, the weight may be max(Z,(X+Y)/2). X may be max(0,min(1, user's age−50)/20)). Y may be a value selected from among 0 to 1 with respect to the weight of baggage input via the user interface 120. Z may be 0 when the health level of the user is healthy and may be 1 when the health level of the user is uncomfortable.

X may be 0 if the user's age is less than 50 and may be 1 if the user's age is equal to or greater than 70.

Y may be 0 if the user does not have baggage and may be 1 when the baggage of the user is 20 Kg, and a value from 0 to 1 may be selected in proportion to the weight of the baggage of the user.

The controller 180 may determine the weight as in the above example and the weight determined from the distance L2 from the first waypoint B to the second waypoint D may be subtracted.

The controller 180 may move the mobile robot 200 to the first traveling path P1 if the first reference value after correction is less than the second reference value, and move the mobile robot 200 to the second traveling path P2 if the second reference value is less than the first reference after correction.

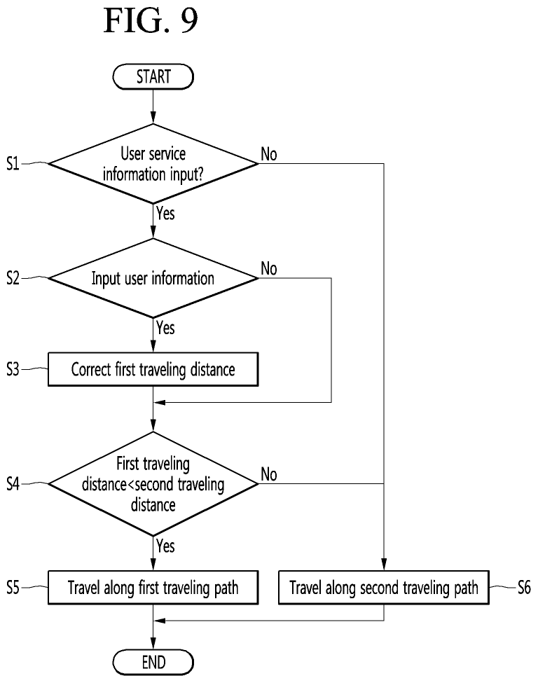

FIG. 9 is a flowchart illustrating a method of controlling a robot system according to an embodiment.

The method of controlling the robot system may control the robot system including the mobile robot 200 traveling by the driving wheels 201 and the user interface 120, via which the user information is input.

The method of controlling the robot system may include input steps S1 and S2 and movement steps S3, S4, S5 and S6.

Input steps S1 and S2 may be steps of inputting the user service information and the user information via the user interface 120.

The user service information may include a request for a guide service provided by the mobile robot and a user's consent to use of the moving walkway.

Input steps S1 and S2 may include an inquiry process S1 in which the robot 100a inquires of the user about various types of inquiries via the output unit 150 such as a display or a speaker.

During the inquiry process S1, the output unit 150 may inquire of the user whether to use a guide service (that is, a consent to use of the guide service) and the user may input a request for the guide service provided by the mobile robot via the user interface 120.

During the inquiry process S1, the output unit 150 may inquire of the user whether to use the moving walkway MW (that is, a consent to use of the moving walkway), and the user may input a consent to use of the moving walkway MW via the user interface 120 or a refusal to use of the moving walkway MW.

With respect to the inquiry of the inquiry process S1, the user may input the use of the moving walkway MW as well as the request for the guide service and the output unit 150 may request input of the user information from the user.

The user information may be information on the condition of the user who will use the mobile robot 200.

The user information may include a user's age, a health level (e.g., healthy or uncomfortable), baggage information (e.g., presence/absence or weight of baggage), etc.

During the input step, the user information may be input via the touch interface 121 or the microphone 122.

During the input step, an object (e.g., an ID card such as a passport) possessed by the user may be recognized by the sensor 123, and the controller 180 may acquire the user information by the object possessed by the user.

The user may input a user's age, a health level (e.g., healthy or uncomfortable), baggage information (e.g., presence/absence or weight of baggage), etc. via the user interface 120, and the input process S2 in which the robot receives such input may be performed.

Meanwhile, when the user inputs non-use of the moving walkway MW with respect to the inquiry of the inquiry process S1, the method of controlling the robot system may move the mobile robot 200 to the second traveling path P2 which does not include the moving walkway MW without performing the input process S2 (S1 and S6).

The method of controlling the robot system may perform the input process S2 without performing the inquiry process S1.

The movement steps S3, S4, S5 and S6 may be steps of selecting one of the first traveling path P1 and the second traveling path P2 and moving the robot to the selected traveling path.

During the movement step, the controller 180 may select one of the first traveling path P1 and the second traveling path P2, using the first traveling distance (the first factor) of the first traveling path P1 including the moving walkway MW, the second traveling distance (the second factor) of the second traveling path P2 which does not include the moving walkway MW and the user information (the third factor) input via the user interface 120 as factors.

During the movement step, the controller 180 may calculate the first reference value according to the first traveling distance and the second reference value according to the second traveling distance and correct the first reference value according to the user information (S3).

The corrected first reference value when the user is older may be less than the corrected first reference value when the user is younger.

The corrected first reference value when baggage is present may be less than the corrected first reference value when baggage is absence.

The corrected first reference value when the health condition is uncomfortable may be less than the corrected first reference value when the health condition is healthy.

During the movement step, the controller 180 may compare the corrected first reference value with the second reference value (S4).

During the movement step, the controller 180 may move the mobile robot 200 to a traveling path having the smaller reference value between the corrected first reference value and the second reference value (S3, S4, S5 and S6).

Meanwhile, when the user information is not input via the user interface 120, during the movement step, the controller 180 may move the mobile robot 200 to a traveling path having the shorter traveling distance between the first traveling distance and the second traveling distance (S2, S4, S5 and S6).

According to the embodiment of the present disclosure, the robot may move along the first traveling path including the moving walkway using the user's age, the health information, baggage, etc. Therefore, it is possible to provide the user with optimal convenience.

In addition, it is possible to simply and rapidly input and process the user information via a touch interface, a microphone or a sensor.

In addition, it is possible to guide a user who needs to use the moving walkway to a path capable of minimizing an actual walking distance of the user even if the total traveling distance increases.

In addition, it is possible to guide a user who does not need to use the moving walkway to a shortest path, thereby decreasing congestion of the moving walkway.

The foregoing description is merely illustrative of the technical idea of the present invention and various changes and modifications may be made by those skilled in the art without departing from the essential characteristics of the present invention.

Therefore, the embodiments disclosed in the present disclosure are intended to illustrate rather than limit the technical idea of the present invention, and the scope of the technical idea of the present invention is not limited by these embodiments.

The scope of protection of the present invention should be construed according to the following claims, and all technical ideas falling within the equivalent scope to the scope of protection should be construed as falling within the scope of the present invention.

What is claimed is:

1. A robot system comprising:
a mobile robot configured to travel by driving wheels;
a user interface, via which user service information and user information are input; and
a controller configured to select one of at least two paths including a path including a moving walkway by using the user information and generate a map of a selected path, if the user service information and the user information are input via the user interface, and
move the mobile robot to the path of a generated map.

2. The robot system of claim 1, wherein the user service information includes at least one of a request for a guide service provided by the mobile robot and a user's consent to use of the moving walkway.

3. The robot system of claim 1, wherein the user information includes at least one of a user's age, a health level or baggage information.

4. The robot system of claim 1,
wherein the at least two paths include a first traveling path including the moving walkway and a second traveling path which does not include the moving walkway, and
wherein the controller selects one of the first traveling path and the second traveling path by using a first traveling distance of the first traveling path, a second traveling distance of the second traveling path and the user information as factors and generates the map.

5. The robot system of claim 4, wherein the controller moves the mobile robot to a traveling path having the shorter traveling distance between the first traveling distance and the second traveling distance, if the user service information is input and the user information is not input.

6. The robot system of claim 4, wherein the controller:
calculates a first reference value according to the first traveling distance and a second reference value according to the second traveling distance, and
corrects the first reference value according to the user information.

7. The robot system of claim 6, wherein the controller moves the mobile robot to a traveling path having the smaller reference value between the corrected first reference value and the second reference value.

8. The robot system of claim 1, wherein the user interface includes a touch interface, via which a user inputs a user's age, baggage information and a health level.

9. The robot system of claim 1, wherein the user interface includes a microphone configured to recognize speech of a user.

10. The robot system of claim 1, wherein the user interface includes a sensor configured to sense an object possessed by a user.

11. A method of controlling a robot system including a mobile robot configured to travel by driving wheels, the method comprising:
inputting user service information and user information via a user interface;
selecting one of at least two paths including a path including a moving walkway using the user information and generating a map, if the user service information and the user information are input; and
moving the mobile robot to a path of the generated map.

12. The method of claim 11, wherein the user service information includes at least one of a request for a guide service provided by the mobile robot and a user's consent to use of the moving walkway.

13. The method of claim 11, wherein the inputting includes an inquiry process of inquiring about a consent to use of a guide service provided by the mobile robot and a user's consent to use of the moving walkway via an output interface.

14. The method of claim 11, wherein the user information includes at least one of a user's age, a health level or baggage information.

15. The method of claim 11, wherein the inputting includes inputting the user information via a touch interface or a microphone or recognizing an object possessed by a user using a sensor.

16. The method of claim 11,
wherein the at least two paths include a first traveling path including the moving walkway and a second traveling path which does not include the moving walkway, and
wherein the selecting includes selecting one of the first traveling path and the second traveling path by using a first traveling distance of the first traveling path, a second traveling distance of the second traveling path and the user information as factors and generating the map.

17. The method of claim 16, wherein the moving includes moving the mobile robot to a traveling path having the shorter traveling distance between the first traveling distance and the second traveling distance, if the user information is not input via the user interface.

18. The method of claim 16, wherein the moving includes:
calculating a first reference value according to the first traveling distance and a second reference value according to the second traveling distance,
correcting the first reference value according to the user information, and
comparing a corrected first reference value with the second reference value.

19. The method of claim 18, wherein the moving includes moving the mobile robot to a traveling path having the smaller reference value between the corrected first reference value and the second reference value.

20. The method of claim 18,
wherein the corrected first reference value when a user is older is less than the corrected first reference value when a user is younger,
wherein the corrected first reference value when baggage is present is less than the corrected first reference value when baggage is absent, and
wherein the corrected first reference value when a health condition is uncomfortable is less than the corrected first reference value when a health condition is healthy.
